(19) United States
(12) Patent Application Publication
(10) Pub. No.: US 2017/0206509 A1
(43) Pub. Date: Jul. 20, 2017

(54) METHODS AND SYSTEMS TO ASSIST TECHNICIANS EXECUTE AND RECORD REPAIRS AND CENTRALIZED STORAGE OF REPAIR HISTORY USING HEAD MOUNTED DISPLAYS AND NETWORKS

(71) Applicants: Alex Beyk, Sunnyvale, CA (US); Tom Shaver, Westerville, OH (US)

(72) Inventors: Alex Beyk, Sunnyvale, CA (US); Tom Shaver, Westerville, OH (US)

(21) Appl. No.: 14/997,480

(22) Filed: Jan. 15, 2016

(51) Int. Cl. G06Q 10/00; G06F 3/01; G06F 3/16; G06Q 10/06

(52) U.S. Cl. CPC G06Q 10/20; G06Q 10/06311; G06Q 10/06315; G06F 3/012; G06F 3/013; G06F 3/167

(57) ABSTRACT

The introduction of head mounted displays (HMDs), heads up displays (HUDs), and near eye displays (NEDs) in conjunction with special methods and networked systems can bridge the gap for repair technicians to provide assessments, inspections, quotes, billing information, and execute repairs while recording their work and maintaining a log of their activities in a hands-free manner in real-time. Furthermore, HMDs can be used to collaborate with other repair technicians and to access instructional diagrams, images, step-by-step instructions, schematics, and videos.

### BACKGROUND

The present invention relates to methods and systems to assist technicians to execute and record repairs via head mounted displays. Furthermore, the present invention relates to methods and systems for technicians to access historical data via head mounted displays located on head mounted displays and on networked systems.

Unless otherwise indicated herein, materials described in this application are not prior art to the claims in this application. Current day personal computing devices including laptops, smartphones, tablets and countless Internet enabled devices have become increasingly prevalent. However, most repair technicians do not fully leverage available computing technologies and devices that can be operated in a hands-free manner. With the introduction of head mounted displays (HMD), heads up displays (HUD), and near eye displays (NED) in conjunction with special methods and networked systems, this gap can be bridged. The present invention will empower repair technicians to record their work and assist them to execute repairs, leverage computers, access archives, submit billing, communicate with headquarters and other parties, and benefit from network services via a hands-free and convenient manner. HMDs may be used for recording work, inventory lookup, step-by-step repair instructions, work order lookup & history lookup, running diagnostics, training certifications, general training, billing applications, communications with offices, other businesses and customers.

### SUMMARY

The features, methods and systems of the present invention may be practiced alone or in combination. Furthermore, the foregoing summary of features, methods and systems are described as examples. They are only illustrative and are not intended to be limiting in any way. Repair technicians can use HMDs to record their work and maintain a log of inspections and/or repairs. Repair technicians can use HMDs to provide repair assessments, inspections, quotes, and billing information. Repair technicians can use HMDs to execute repairs to assist them by collaborating in real-time with other repair technicians and by utilizing text, images, audio, and/or video. Repair technicians with network connected HMDs may access network systems offering historical repair information including audio commands, diagrams, images, step-by-step instructions, schematics, and/or videos.

### BRIEF DESCRIPTION OF DRAWINGS

In order that the present invention may be more clearly ascertained, some embodiments will now be described, by way of example, with reference to the accompanying drawings, in which:

FIG. 1 illustrates one embodiment of a head mounted display in accordance with the present invention;

FIGS. 2 through 4 illustrate several embodiments of head mounted displays and how humans may wear the head mounted display in accordance with the present invention;

FIG. 5 illustrates several embodiments of head mount displays connecting to other devices via a multiplicity of networking options in accordance with the present invention;

FIG. 6 illustrates the ability to use HMDs to identify a multiplicity of vehicles of transportation, process unique identification information and record videos during the repair of the vehicles;

FIG. 7 illustrates the main build-in hardware modules of a head mounted display used for processing, memory storage, memory logic, networking, and display;

FIG. 8 illustrates the main built-in input, output and orientation modules in the head mounted display in accordance with the present invention;

FIG. 9 illustrates the main built-in application modules in the head mounted display in accordance with the present invention;

FIG. 10 illustrates methods to help repair technicians execute and record repairs using head mounted displays and access centralized storage of repair history using networks;

FIG. 11 illustrates methods to identify vehicles using head mounted displays;

FIG. 12 illustrates methods to generate repair estimates and process repair estimates via networks;

FIG. 13 illustrates methods to record repairs, communicate status with headquarters, and keep customers updated using head mounted displays and networks;

FIG. 14 illustrates methods to generate additional repair estimates and process additional repair estimates via networks, communicate status with headquarters, and keep customers updated using head mounted displays and networks;

FIG. 15 illustrates methods to assist technicians collaborate, run repair diagnostics, and activate emergency alarms;

FIG. 16 illustrates methods to help repair technicians communicate status with headquarters using head mounted displays, keep customers and 3rd parties updated via networks, and process invoices using networks; and

FIG. 17 illustrates methods to process invoices, notify customers, provide customers with recorded repair videos, and accept feedback via networks.

### DETAILED DESCRIPTION

The present invention relates to methods and systems to help repair technicians execute and record repairs and centralized storage of repair history using a head mounted display (HMD) and networks. With the introduction of head mounted displays (HMDs), heads up displays (HUDs), near eye displays (NEDs), and eye displays (EDs) in conjunction with special methods and systems, these technologies may be used to help streamline the check-in of a vehicle for servicing. Furthermore, the methods of leveraging hands-free recording of vehicle repair work using a HMD may be used to help improve quality of service for customers and vehicle dealerships.

The following detailed description describes features, functions, methods, and systems of the present invention with references to the accompanying figures. In the figures, similar symbols typically identify similar components. The illustrations in the figures, methods, and systems can be arranged, substituted, combined, separated, and designed in a variety of different configurations without departing from the spirit or scope of the subject matter presented herein. They are not meant to be limiting and aspects of the figures, methods, and systems can be arranged and combined in a wide variety of different configurations. In certain instances, well known processes and steps have not been described in detail in order to maintain focus on the aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

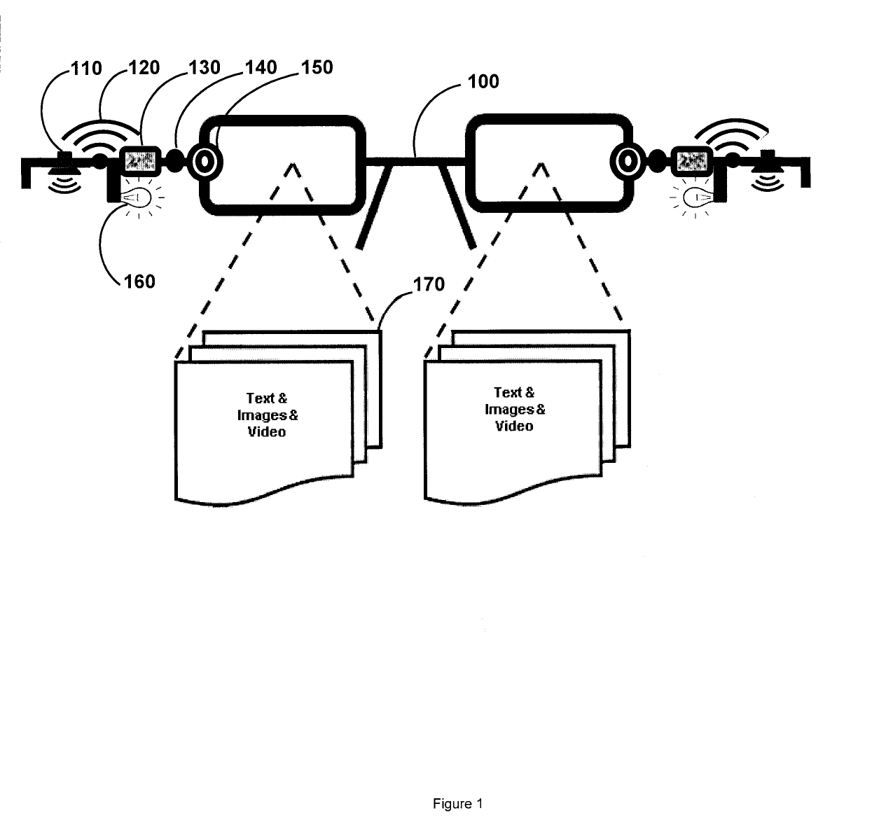

FIG. 1 illustrates one exemplary HMD device 100 which may be used to display text, images and video in the exemplary projection 170 of the HMD. This example of one embodiment of a HMD includes a speaker module 110, WIFI (aka wireless) networking module 120, a touchpad module 130, a microphone module 140, a still and video camera module 150, and a light module 160. The aforementioned modules may be included in any order and in any number in the example HMD.

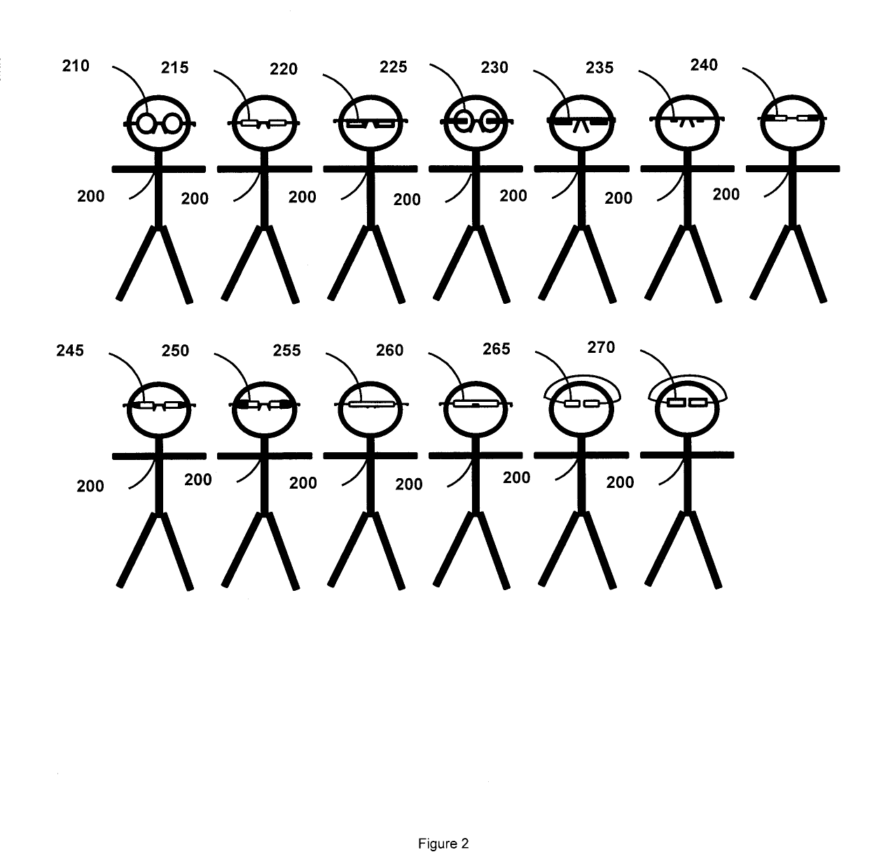

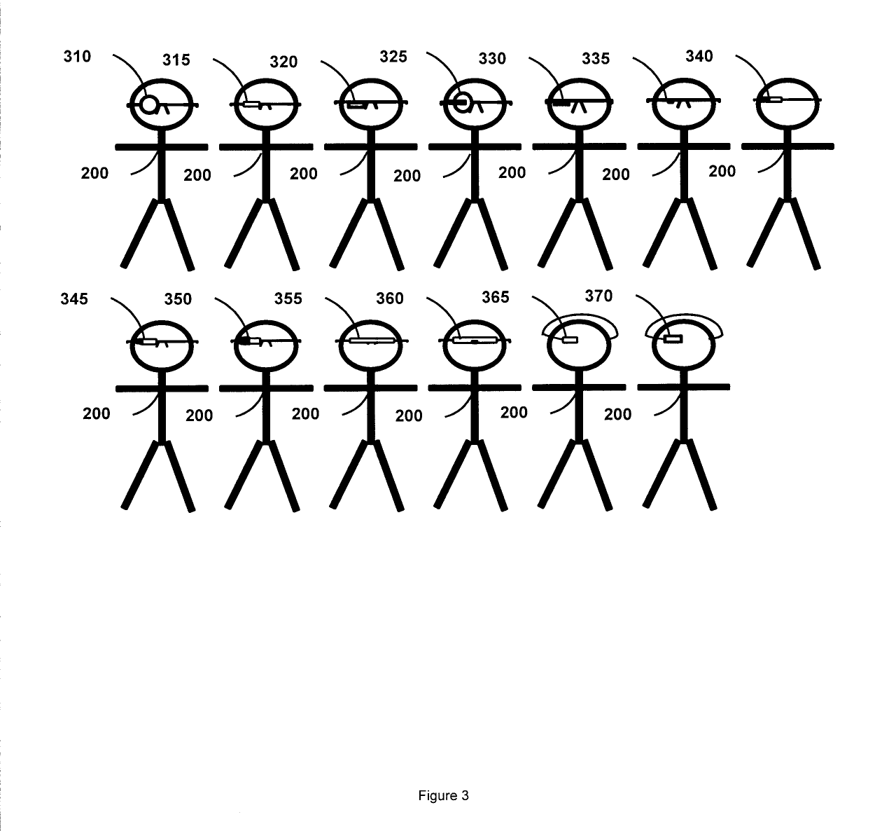

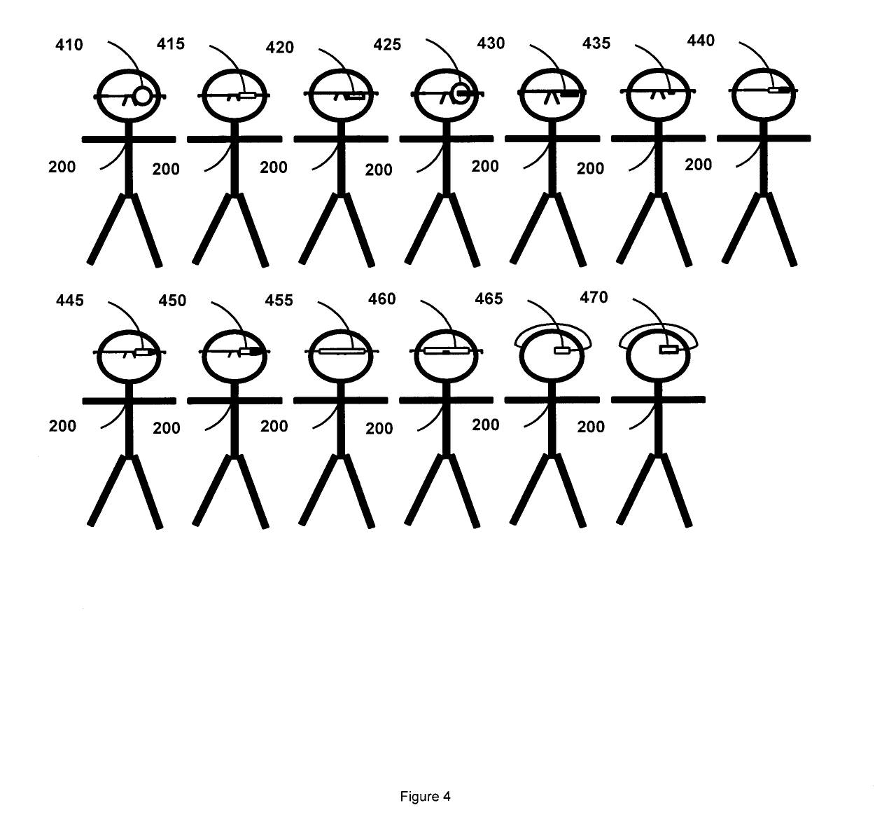

FIGS. 2 through 4 illustrate examples of how a human 200 may wear HMD devices 210, 215, 220, 225, 230, 235, 240, 245, 250, 255, 260, 265, 270, 310, 315, 320, 325, 330, 335, 340, 345, 350, 355, 360, 365, 370, 410, 415, 420, 425, 430, 435, 440, 445, 450, 455, 460, 465, and 470. HMDs may be operated by a human 200, mounted on the head with HMD display capabilities and other modules on both the left and right sides in stereo as illustrated in FIG. 2, on the right side as illustrated in FIG. 3, or on the left side as illustrated in FIG. 3.

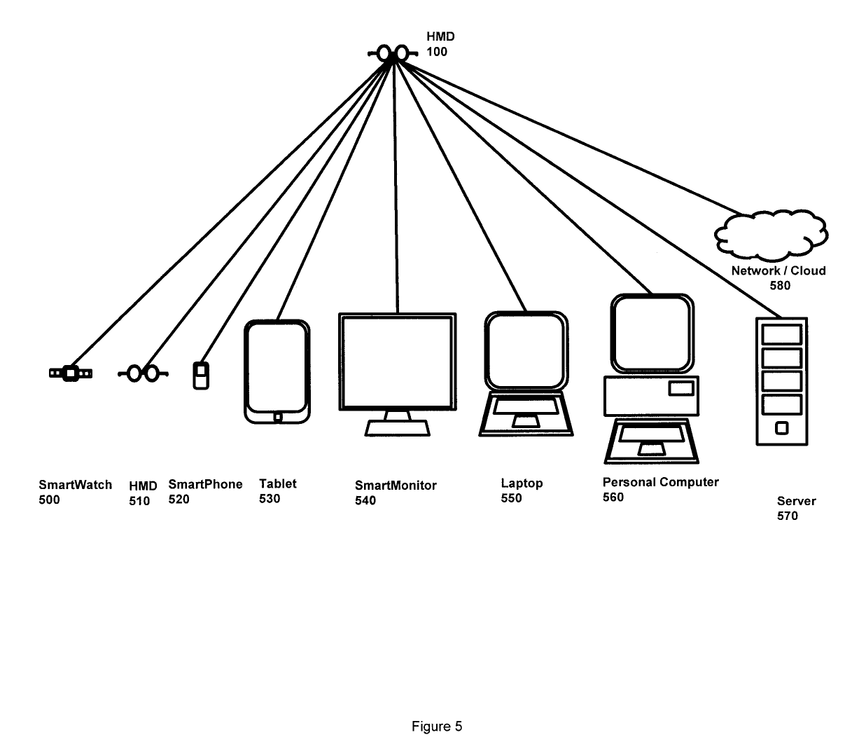

FIG. 5 illustrates the ability to use a HMD 100 to connect to external compute devices, storage devices, smart devices and networks. Examples include connections via Bluetooth, WIFI, LAN, WAN, and Radio to devices including a smartwatch 500, smartglass(es) or HMDs 510, smartphone 520, smart tablet or tablet 530, smart monitor or all-in-one computer 540, laptop 550, personal computer 560, and server 570. HMDs may connect to the aforementioned devices in local locations within Intranets and remote locations within Internets using networks/Clouds 580. HMDs connected to these external devices may leverage additional resources for computing, storage, user identification, and increased network throughput.

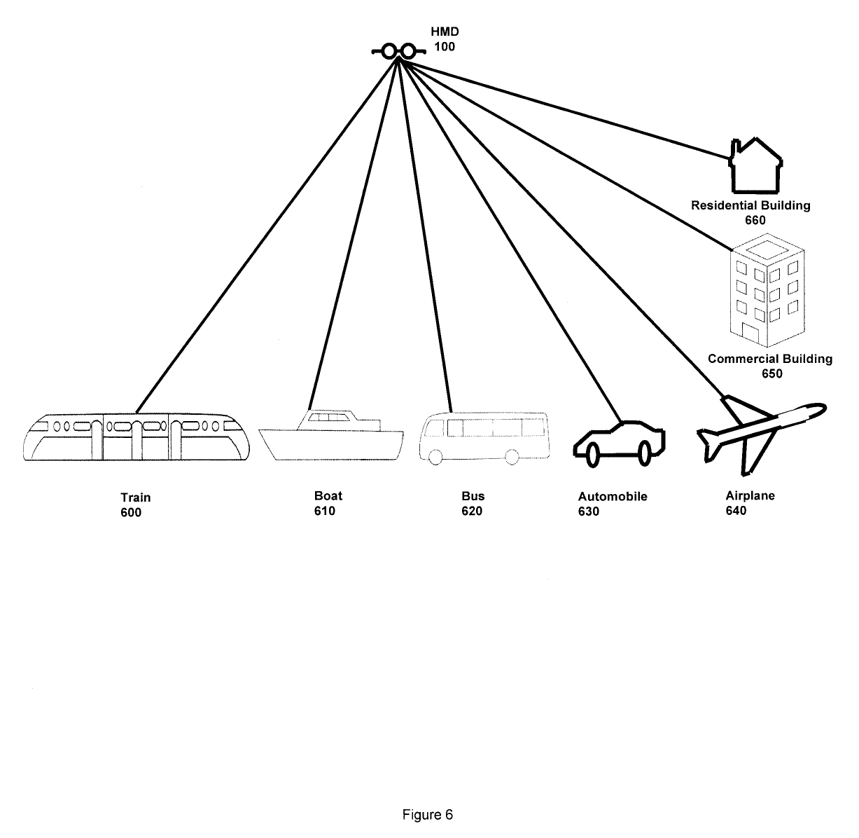

FIG. 6 illustrates the ability to use a HMD 100 to identify a multiplicity of vehicles of transportation, process unique identification information and record videos during the repair of the vehicles. Examples include; a train 600, boat 610, bus 620, automobile or car 630, airplane 640, commercial building 650, and residential building 660.

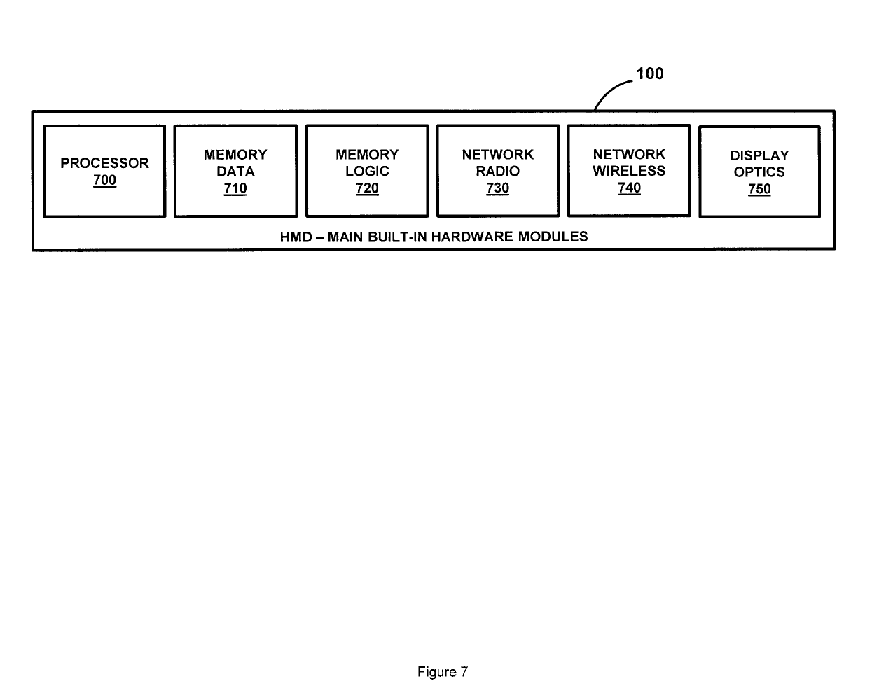

FIG. 7 illustrates the main built-in hardware modules or components in a HMD 100 including a processor 700 for program execution, memory data 710 for data storage, memory logic 720 for application loading and execution, network radio 730 for communications, network wireless 740 for communications, and display optics 750 to display, project and reflect text and images. These modules will be leveraged by the present invention allowing users to communicate, view, edit, record, replay, sign, and manage recordings.

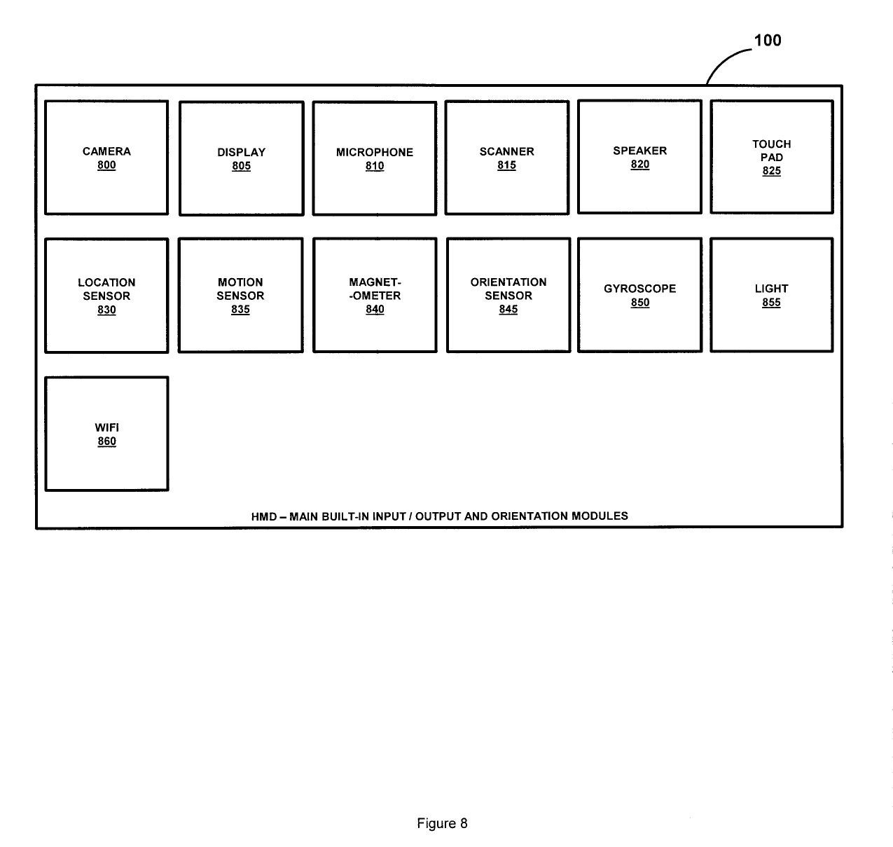

FIG. 8 illustrates the main input, output and orientation modules or components inherent in a HMD 100 including a camera 800, display 805, microphone 810, scanner 815, speaker 820, touch pad 825, location sensor 830, motion sensor 835, magnetometer 840, orientation sensor 845, gyroscope 850, light 855, and WIFI (aka wireless) network communication module 860. These modules will be leveraged by the present invention allowing users to communicate, listen, view, edit, record, replay, sign, and manage repair recordings.

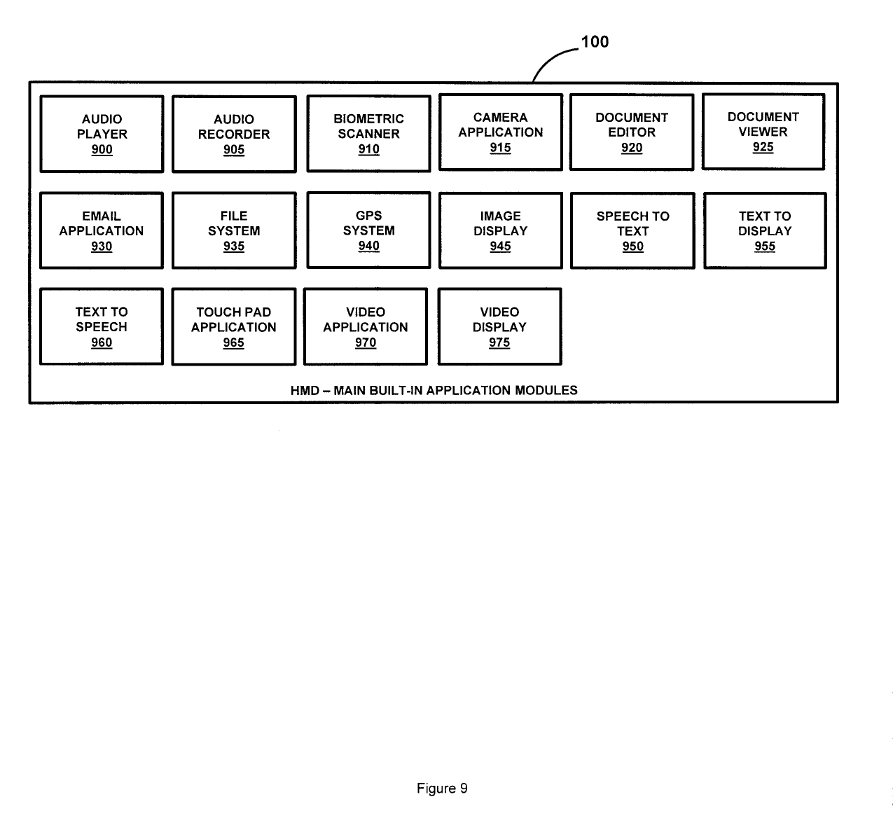

FIG. 9 illustrates the main built-in application modules or components provided by a HMD 100 including an audio player 900, audio recorder 905, biometric scanner 910, camera application 915, document editor 920, document viewer 925, email application 930, file system 935, GPS system 940, image display 945, speech to text 950, text to display 955, text to speech 960, touch pad application 965, video application 970, and video display 975. These modules will be leveraged by the present invention allowing users to communicate, listen, view, edit, record, replay, sign, and manage repair recordings.

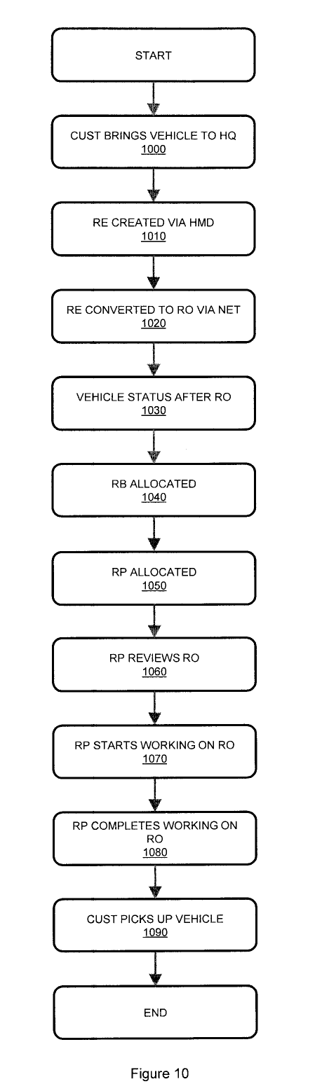

FIG. 10 illustrates the overall end-to-end process how the HMD 100 may be used including the steps where the CUST (Customer) brings the vehicle to the HQ (Headquarters/Repair Facility) 1000, a RE (Repair Estimate) is created via the HMD 1010, the RE is converted to an RO (Repair Order) via the NET (Network) 1010, the vehicle status is provided after the RO is generated 1020, a RB (Repair Bay) is allocated 1040, a RP (Repair Person) is allocated 1050, the RP reviews the RO 1060, the RP starts working on the RO 1070. Examples of the RP work may include inspections, general maintenance, specific service and repairs. The RP completes working on the RO 1080, and the CUST picks up the vehicle 1090. The overall end-to-end process may be applied to the HQ's existing and new inventory control system and accounting system.

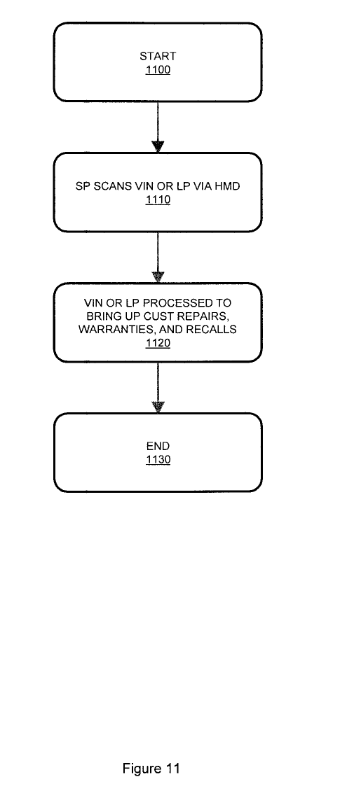

FIG. 11 illustrates the steps where the CUST bringing a vehicle to the HQ. Upon arrival of the vehicle, the SP (Service Person) will scan the VIN (Vehicle Identification Number) or LP (License Plate) via HMD 1110. Thereafter, the VIN or LP will be processed to bring up the CUST repairs, warranties and recalls as outlined in step 1120. The SP will discuss with the CUST if there are any additional repairs and if so, the SP will add them to the RO.

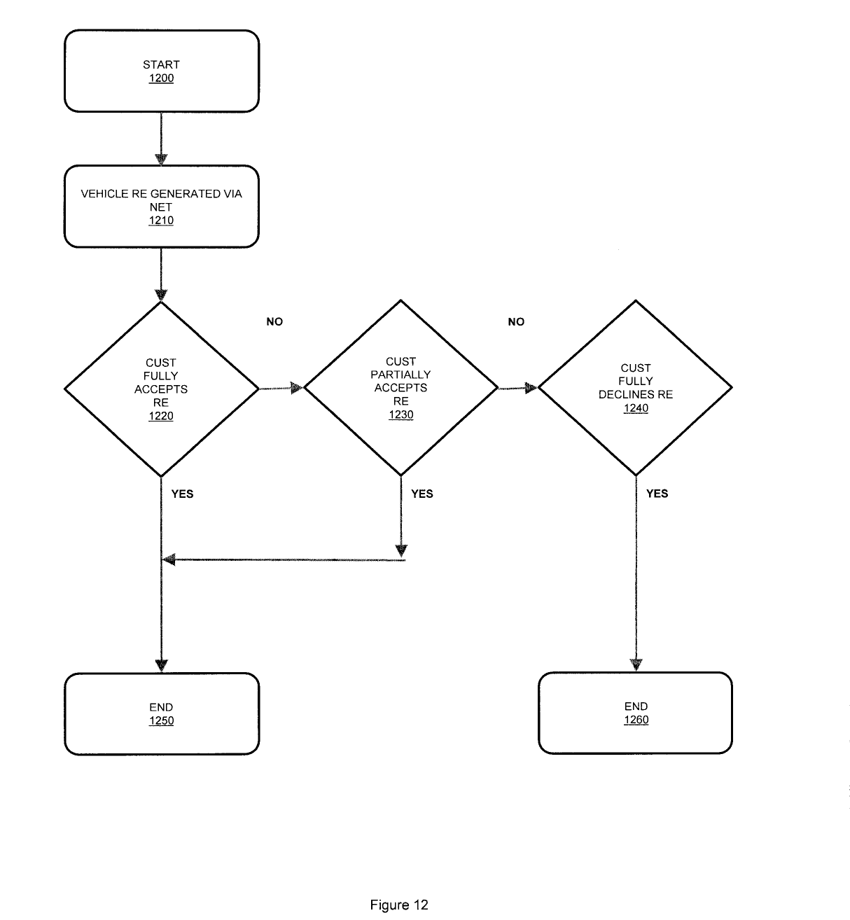

FIG. 12 illustrates the steps where the vehicle RE is generated 1210 and reviewed by the CUST. The CUST may decide to fully accept the RE 1220, partially accept the RE 1230 or fully decline the RE 1240.

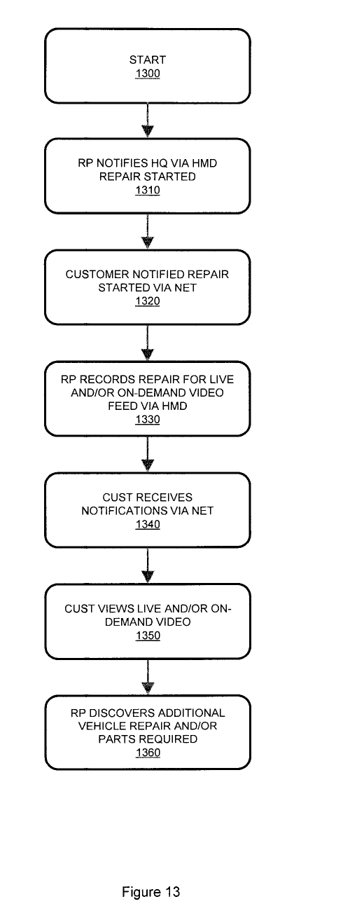

FIG. 13 illustrates the steps where the RP notifies HQ via the HMD the repair has started 1310, after which, the CUST is notified via the NET the repair has started 1320. The RP may record the repair work for live and/or on-demand video via the HMD 1330. The CUST may receive repair work notifications via the NET 1340. The CUST may view the live and/or on-demand video via the NET 1350. During the repair work, the RP may discover additional vehicle repair and/or parts are required 1360.

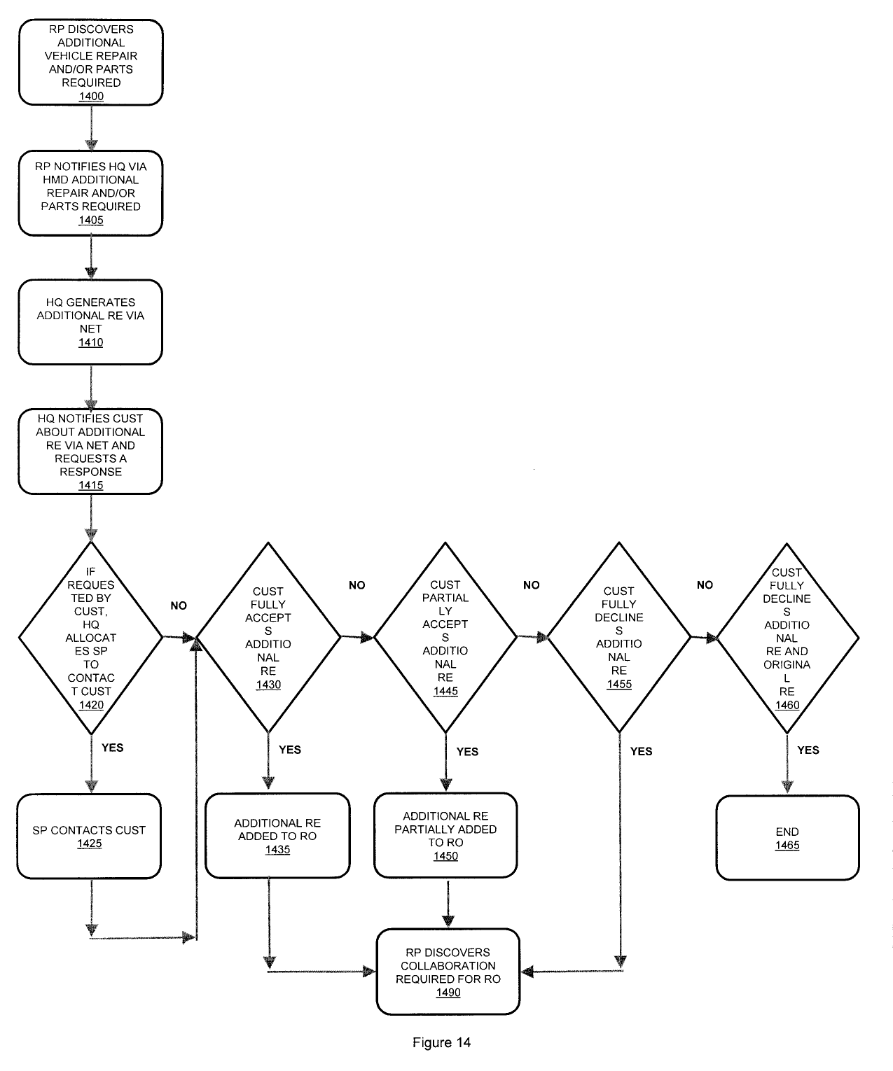

FIG. 14 illustrates the steps where the RP discovers additional vehicle repair and/or parts are required 1400, after which the RP notifies HQ via the HMD additional repairs and/or parts are required 1405. HQ generates an additional RE via the NET 1410 and HQ notifies CUST about additional RE via the NET and requests a response 1415. If requested by CUST, HQ allocates an SP to contact CUST 1420. SP contacts CUST 1425. CUST fully accepts additional RE 1430, CUST partially additional accept RE 1445, CUST fully declines additional RE 1455, or CUST fully declines additional RE and original RE 1460. If the CUST fully accepts RE, an additional RE is added to the RO 1435. If the CUST partially accepts the RE, an additional RE is added to the RO 1450. During these steps the RO may discover collaboration is required for the RO 1490 with the CUST.

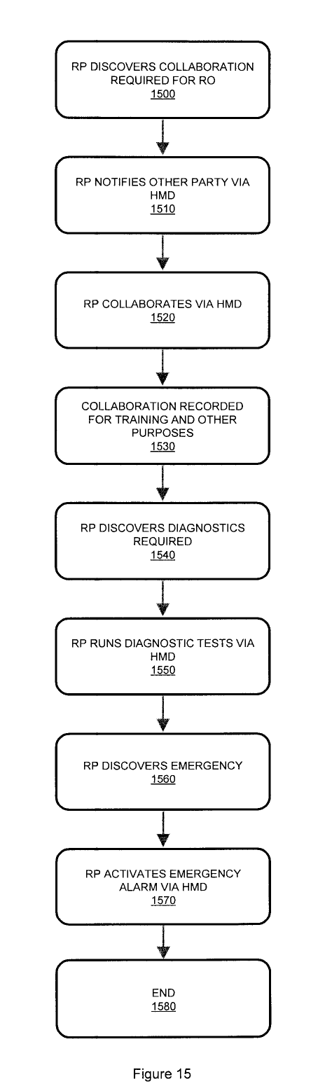

FIG. 15 illustrates the steps during the process of the RP working on the additional RE, the RP discovers collaboration is required for the RO. RP notifies other party via HMD 1510. Examples of the RP work may include inspections, general maintenance, specific service and repairs. RP collaborates via the HMD 1520 and the collaboration is recorded for training and other purposes 1530. The RP may discover diagnostics are required 1540. The RP my run diagnostic tests via the HMD 1550. RP may discover an emergency 1560. RP may activate an emergency alarm via the HMD 1570.

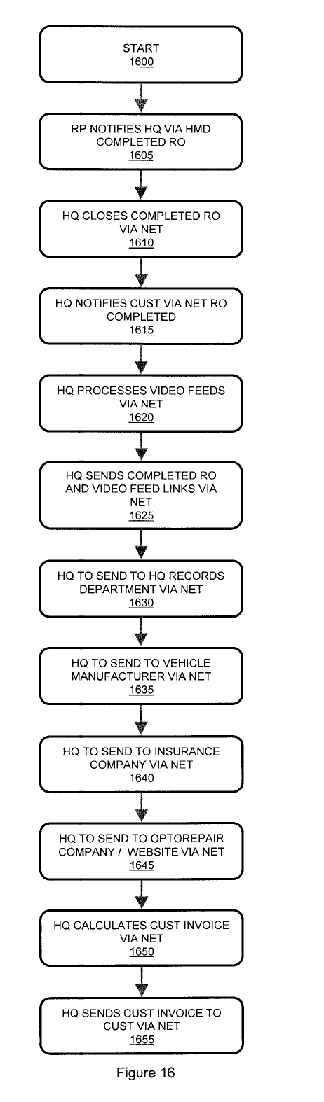

FIG. 16 illustrates the steps where the RP notifies HQ via the HMD about the RO being completed 1605. HQ closes the completed RO via the NET 1610. HQ notifies CUST via the NET the RO is completed 1615. HQ processes video feeds via NET 1620. HQ sends completed RO and video feed links via NET 1625. HQ sends RO and video feeds to HQ records department via NET 1630. HQ sends RO to vehicle manufacturer via NET 1635. HQ sends RO to insurance company via NET 1640. HQ sends RO and video feeds to OptoRepair Company 1645. HQ calculates CUST invoice via NET 1650. HQ sends CUST invoice to the CUST via NET 1655.

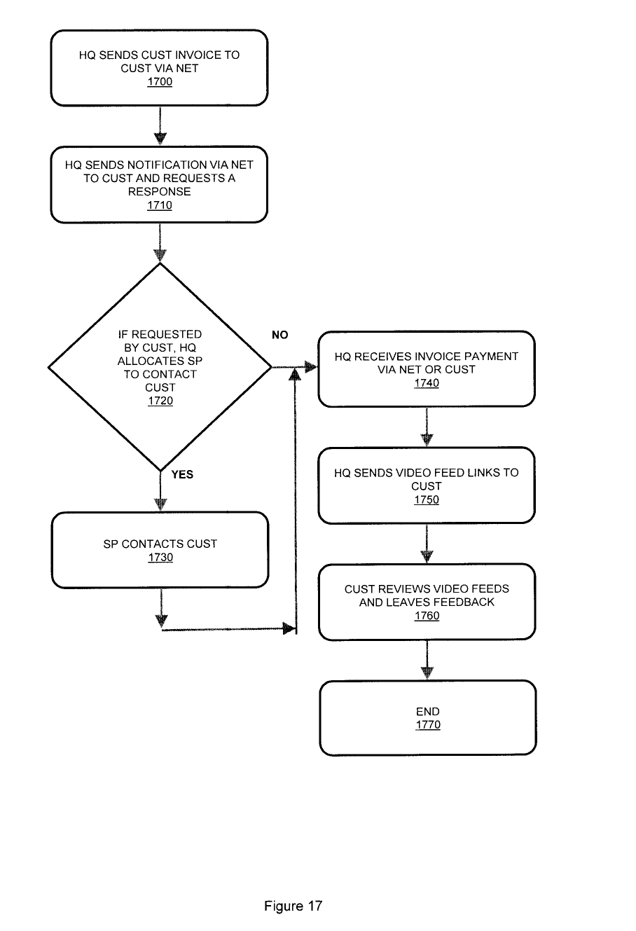

FIG. 17 illustrates the steps where HQ sends CUST invoice to the CUST via NET. HQ sends notification via NET to CUST and requests a response 1710. If requested by CUST, HQ will allocate a SP to contact the CUST 1720 and the SP will contact the CUST 1730. HQ receives invoice payment via NET or CUST 1740. HQ sends video feed link to CUST 1750. CUST will review the video feed and may leave feedback 1760.

While various aspects and embodiments have been disclosed in the present invention, other aspects and embodiments will be apparent to those skilled in the art. The various aspects and embodiments disclosed herein are for purposes of illustration and are not intended to be limiting. The true scope and spirit are indicated by the following claims, along with the full scope of equivalents to which such claims are entitled. Furthermore, the terminology used herein is for the purpose of describing particular embodiments only and is not intended to be limiting in any way.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized vehicle repair management system, a method for streamlining the check-in of a vehicle for servicing, wherein a vehicle is of an airplane automobile, boat, bus, car, and train, the method comprising:
identifying at least one of a Vehicle Identification Number (VIN), a vehicle registration, and a vehicle license plate associated with a vehicle via a Head Mounted Display (HMD) worn by a service person (SP);
checking in the identified vehicle;
creating at least one of a repair estimate (RE) and repair order (RO) associated with the identified vehicle;
retrieving at least one of a RE and RO associated with the identified vehicle;
allocating a suitable holding location or repair bay (RB) for the identified vehicle;
allocating at least one repair person (RP) associated with servicing the identified vehicle; and
allocating at least one part associated with servicing the identified vehicle.

2. The method of claim 1, wherein the VIN or vehicle license plate is used to retrieve at least one of a service appointment, RE, RO, repair history, recall history, accident history, and ownership history.

3. The method of claim 1, wherein the VIN or vehicle license plate is used to create at least one of a service appointment, RE, and RO and shared with the computerized vehicle repair management system.

4. The method of claim 1, wherein the HMD is used to identify one of a plurality of vehicles associated with the driver.

5. The method of claim 1, wherein the HMD is used to interview a driver associated with the identified vehicle.

6. The method of claim 1, wherein the HMD is used to record interview notes by the SP and stored as a part of at least one of a SE and RO and shared with the computerized vehicle repair management system.

7. The method of claim 1, wherein the HMD is used to record at least one of initial diagnosis, inspection, general maintenance, specific service, and repairs per the repair plan as a part of at least one of a SE and RO and shared with the computerized vehicle repair management system.

8. In a computerized memorialization system, a method for hands-free recording of vehicle repair work using a Head Mounted Display (HMD), wherein a vehicle is one of an airplane, an automobile, a boat, a bus, a car and a train, the method comprising:
retrieving from a server a repair order (RO) associated with repairing an identified vehicle;
sending the RO to a Head Mounted Display (HMD) associated with a repair person (RP); and
receiving from the HMD at least one sequence including repair work on the identified vehicle by the RP wearing the HMD, wherein the at least one sequence of the repair work is recorded using the HMD under hands-free control of the RP, and wherein the at least one sequence includes at least one of an audio track, a textual annotation, and a video track.

9. The method of claim 8, further comprising recording via the HMD the repair work time.

10. The method of claim 8, further comprising controlling via the HMD the sequence of repair work being recorded using the HMD using at least one of a start-work command, pause-work command, stop-work command, start-record command, pause-record command, stop-record command, add-note command, play-back-last command, delete-last command, share-last command, and share-all command.

11. The method of claim 8, further comprising creating via the HMD an additional repair estimate (RE), sharing the additional RE with the computerized memorialization system and triggering a customer notification.

12. The method of claim 8, further comprising triggering a diagnostic test sequence and retrieving corresponding diagnostic results via the HMD using at least one of an audio command, a limbic movement, a head movement, an eyelid movement, and an eye movement.

13. The method of claim 8, further comprising sharing via the HMD diagnostic data from the diagnostic test sequence with the computerized memorialization system integrated with existing and new inventory control system and accounting system.

14. The method of claim 8, further comprising registering via the HMD with a parts inventory system a vehicle part used for the repair order (RO).

15. The method of claim 12, further comprising updating via the HMD a parts inventory system wherein the parts inventory system is at least one of a part of the computerized memorialization system and a part of 3rd party system.

16. The method of claim 8, further comprising at least one of triggering an alarm and broadcasting a distress signal using the HMD by detecting at least one of a code word, a safe word, a gesture, a physical movement, a sound, and a utterance.

17. The method of claim 8, further comprising at least one of triggering an alarm and broadcasting a distress signal using the HMD by detecting at least one of an irregular body pulse, an irregular body temperature, body movement latency over time, and excessive force to or excessive acceleration of the HMD.

18. The method of claim 8, further comprising communicating via the HMD completion of the repair work, sharing the completion status with the computerized memorialization system integrated with existing and new inventory control system and accounting system, thereby generating a notification to at least one of a headquarters, manufacturers, insurance companies, customers, and 3rd parties.

19. The method of claim 18, whereby completion of the RO automatically triggers the computerized memorialization system to process at least one of customer invoice calculation, customer invoice notification, future customer appointment scheduling, and sharing of RO video recordings.

20. A computerized memorialization system useful in association with hands-free recording of vehicle repair work using an Head Mounted Display (HMD), wherein a vehicle is one of an airplane, an automobile, a boat, a bus, a car, and a train, the memorialization system comprising:
a server configured to archive, calculate, communicate, index, process, retrieve, send, and store a repair order (RO) associated with repairing an identified vehicle;
a wireless interface configured to transmit the RO to at least one Head Mounted Display (HMD), and further configured to receive from the HMD a recording of a repair per a repair plan as a part of the RO; and
wherein the server is further configured to store the recording of the repair per the RO.

21. A Head Mounted Display (HMD) useful in association with a computerized memorialization system for hands-free recording of vehicle repair work using an Head Mounted Display (HMD), wherein a vehicle is one of an airplane, an automobile, a boat, a bus, a car, and a train, the HMD comprising:
a wireless interface configured to receive a repair order (RO) from a computerized memorialization system, the RO associated with repairing an identified vehicle;
a sensor configured to record at least one of an initial diagnosis, an inspection, a general maintenance, a specific service, and a repair per a repair plan as a part of the RO, and wherein the at least one of the initial diagnosis, the inspection, the general maintenance, the specific service; and
wherein the interface is further configured to share the repair with the computerized memorialization system.
